(19) United States
(12) Patent Application Publication
(10) Pub. No.: US 2013/0144863 A1
(43) Pub. Date: Jun. 6, 2013

(54) System and Method for Gathering, Restructuring, and Searching Text Data from Several Different Data Sources

(71) Applicants: Ron Mayer, Newark, CA (US); Robert L. Batty, Walnut Creek, CA (US)

(72) Inventors: Ron Mayer, Newark, CA (US); Robert L. Batty, Walnut Creek, CA (US)

(73) Assignee: FORENSIC LOGIC, INC., Walnut Creek, CA (US)

(21) Appl. No.: 13/481,729

(22) Filed: May 25, 2012

Related U.S. Application Data
(60) Provisional application No. 61/519,633, filed on May 25, 2011.

(51) Int. Cl. G06F 17/30

(52) U.S. Cl. CPC G06F 17/30864
USPC 707/711

(57) ABSTRACT

Collecting and analyzing crime related information is one of the most important tasks of law enforcement agencies. Traditionally, crime related information is entered into structured database that allows law enforcement officers to later search the database. However, the user interface is often not well suited for easily finding relevant documents quickly. To improve the situation, a law enforcement information system that stores data in two different types of formats is disclosed. Crime related information is stored both in a traditional structured database and in a modified natural language database. The modified natural language database is then indexed and may be searched with an internet search engine type of user interface.

### RELATED APPLICATIONS

The present application claims the benefit of the U.S. Provisional patent application having serial number filed on May 25, 2011.

### TECHNICAL FIELD

The present invention relates to the field of collecting data from a wide variety of sources, restructuring the data, and searching the data. In particular, but not by way of limitation, the present disclosure teaches techniques for collecting, restructuring, and searching text data used by law enforcement officials.

### BACKGROUND

Information is one of the most important resources to any law enforcement agency. One small piece of information such as license plate number, a tattoo description, or telephone number can mean the difference as to whether a particular crime is solved or not. Information is also very important for officer safety since approaching a suspect's vehicle or home can be very dangerous. Thus, collecting and analyzing crime related information is one of the most important tasks of law enforcement agencies.

Police departments, sheriff offices, correctional facilities, criminal courts, federal agencies, and other sources collect a large amount of information related to crimes and criminal behavior. The crime-related information is collected in police crime reports, correctional facility bookings, witness interviews, email messages between law enforcement officials, and many other data repositories. Most of these data repositories are now electronic but there are no widely followed standards for storing this crime-related information. Furthermore, there are many additional information sources from other entities may also contain important information that can be useful for solving crimes. However, this additional information is generally not integrated with conventional law enforcement agency records management systems.

Although a fairly large amount of useful crime related information is collected by various law enforcement agencies, the crime related information is often stored in many different databases repositories. Each of these different database repositories may use different user interfaces. Thus, it is very difficult for law enforcement officials to “connect the dots” by combining information from several different information sources to provide a more coherent understanding of a crime.

Even when crime-related information is stored electronically and made available to law enforcement officers for searching, the various crime-related database systems are often non intuitive and difficult to use. For example, many crime-related database systems provide a user interface consisting of a large multi-field search form that requires significant amounts of training to use effectively. Furthermore, these conventional database systems are not easily used by a law enforcement officer that is out in the field. Thus, it would be very desirable to provide law enforcement officers with improved tools for collecting, storing, and searching repositories of crime related information.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates a diagrammatic representation of machine in the example form of a computer system within which a set of instructions, for causing the machine to perform any one or more of the methodologies discussed herein, may be executed.

FIG. 2 conceptually illustrates law enforcement information system that collects information from many sources, processes the information, and makes the information available to users with two different types of databases.

FIG. 3 illustrates a high-level flow diagram that describes the operation of the law enforcement information system of FIG. 2.

FIG. 4 illustrates a flow diagram that describes how structured, semi-structured, and unstructured data is converted into records for a structured database in the law enforcement information system of FIG. 2.

FIG. 5A illustrates a flow diagram that describes how structured, semi-structured, and unstructured data records are converted into data records for a modified natural language database.

FIG. 5B illustrates a conceptual diagram that describes how structured, semi-structured, and unstructured data record may be processed into a modified natural language record.

FIG. 6 illustrates a screen shot of a conventional database query screen.

FIG. 7 illustrates a block diagram of a search system that uses the modified natural language database in the law enforcement information system of FIG. 2.

FIG. 8 illustrates a screen shot of an output display from a search made using the modified natural language database.

### DETAILED DESCRIPTION

The following detailed description includes references to the accompanying drawings, which form a part of the detailed description. The drawings show illustrations in accordance with example embodiments. These embodiments, which are also referred to herein as “examples,” are described in enough detail to enable those skilled in the art to practice the invention. It will be apparent to one skilled in the art that specific details in the example embodiments are not required in order to practice the present invention. For example, although some of the embodiments are disclosed with reference to eXtensible Markup Language (XML), the teachings of the present disclosure may be used with many different data organization systems. The example embodiments may be combined, other embodiments may be utilized, or structural, logical and electrical changes may be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Computer Systems

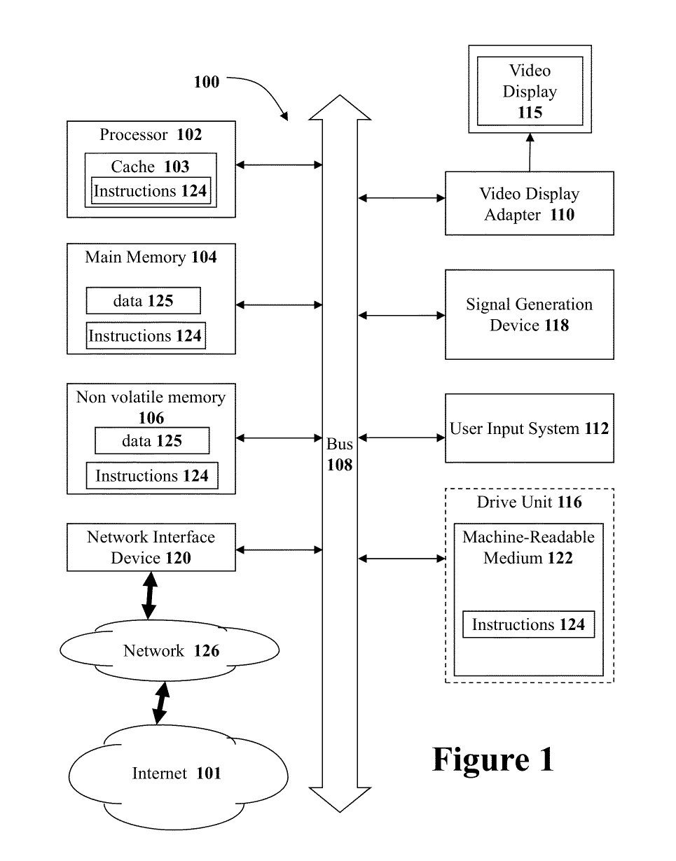

The present disclosure concerns digital computer systems. FIG. 1 illustrates a diagrammatic representation of a machine in the example form of a computer system 100 that may be used to implement portions of the present disclosure. Within computer system 100 of FIG. 1, there are a set of instructions 124 that may be executed for causing the machine to perform any one or more of the methodologies discussed within this document.

In a networked deployment, the machine of FIG. 1 may operate in the capacity of a server machine or a client machine in a client-server network environment, or as a peer machine in a peer-to-peer (or distributed) network environment. The machine may be a personal computer (PC), a tablet computer, a set-top box (STB), a Personal Digital Assistant (PDA), a cellular telephone, a web appliance, a server, a network router, a network switch, a network bridge, a video game console, or any machine capable of executing a set of computer instructions (sequential or otherwise) that specify actions to be taken by that machine. Furthermore, while only a single machine is illustrated, the term “machine” shall also be taken to include any collection of machines that individually or jointly execute a set (or multiple sets) of instructions to perform any one or more of the methodologies discussed herein.

The example computer system 100 of FIG. 1 includes a processor 102 (e.g., a central processing unit (CPU), a graphics processing unit (GPU) or both), a main memory 104, and a non-volatile memory 106, which communicate with each other via a bus 108. The non-volatile memory 106 may comprise flash memory and may be used either as computer system memory, as a file storage unit, or both. Both the main memory 104 and a non-volatile memory 106 may store instructions 124 and data 125 that are processed by the processor 102.

The computer system 100 may include a video display adapter 110 that drives a video display system 115 such as a Liquid Crystal Display (LCD) in order to display visual output to a user. The computer system 100 may also include other output systems such as signal generation device 118 that drives an audio speaker.

Computer system 100 includes a user input system 112 for accepting input from a human user. The user input system 112 may include an alphanumeric input device such as a keyboard, a cursor control device (e.g., a mouse or trackball), touch sensitive pad (that may be overlaid on top of video display 115), a microphone, or any other device for accepting input from a human user.

The computer system 100 may include a disk drive unit 116 for storing data. The disk drive unit 116 includes a machine-readable medium 122 on which is stored one or more sets of computer instructions and data structures (e.g., instructions 124 also known as ‘software’) embodying or utilized by any one or more of the methodologies or functions described herein. The instructions 124 may also reside, completely or at least partially, within the main memory 104 and/or within a cache memory 103 associated with the processor 102. The main memory 104 and the non-volatile memory 106 associated with the processor 102 also constitute machine-readable media.

The computer system 100 may include one more network interface devices 120 for transmitting and receiving data on one or more networks 126. For example wired or wireless network interfaces 120 may couple to a local area network 126. Similarly, a cellular telephone network interface 120 may be used to couple to a cellular telephone network 126. The various different networks 126 are often coupled directly or indirectly to the global internet 101. The instructions 124 and data 125 used by computer system 100 may be transmitted or received over network 126 via the network interface device 120. Such transmissions may occur utilizing any one of a number of well-known transfer protocols such as the well-known File Transport Protocol (FTP).

Note that not all of the parts illustrated in FIG. 1 will be present in all embodiments. For example, a computer server system may not have a video display adapter 110 or video display system 115 if that server is controlled through the network interface device 120. Similarly, a tablet computer or cellular telephone will generally not have a disk drive unit 116.

While the machine-readable medium 122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies described herein, or that is capable of storing, encoding or carrying data structures utilized by or associated with such a set of instructions. The term “machine-readable medium” shall accordingly be taken to include, but not be limited to, solid-state memories, optical media, battery-backed RAM, and magnetic media.

For the purposes of this specification, the term “module” includes an identifiable portion of code, computational or executable instructions, data, or computational object to achieve a particular function, operation, processing, or procedure. A module need not be implemented in software; a module may be implemented in software, hardware/circuitry, or a combination of software and hardware.

Crime Related Information

Crime related information is stored electronically at a wide variety of different entities in a wide variety of different data formats. Police departments, sheriff offices, correctional facilities, criminal courts, and other sources collect a large amount of information related to crimes and criminal behavior. In addition to local law enforcement there are other law enforcement agencies such as the Federal Bureau of Investigation (FBI), the Drug Enforcement Agency (DEA), the Department of Alcohol, Tobacco, and Firearms (ATF) that collect information on criminal behavior.

Police departments collect and store crime reports and investigation information in electronic databases. The police collected crime information is generally made available for searching by law enforcement officers. In addition, common traffic ticket information is collected and even simple traffic information can sometimes provide valuable information for solving a crime. Various informal information exchanges also occur between various law enforcement officers. For example, local police officers often belong to a local crime mailing list where local crimes are discussed.

Criminal court systems and correctional facilities also collect and store electronic crime-related information can be very valuable in solving crimes. Criminal courts store information about criminal judicial proceedings and convictions. Correctional facilities store information about detainees that have been processed for admission including detailed physical information about convicted criminals and criminal suspects. Much of this criminal court and correctional facility collected information is available to law enforcement officers but may require accessing a different database system that uses a different type of user interface.

In addition to the formal crime related data repositories, there many unofficial electronic sources of information that can provide law enforcement officers with valuable information for solving cases. Local news stories on web sites will include additional witness accounts that may have not been collected by law enforcement. Social media sites provide a wealth of information that various criminals disclose about themselves.

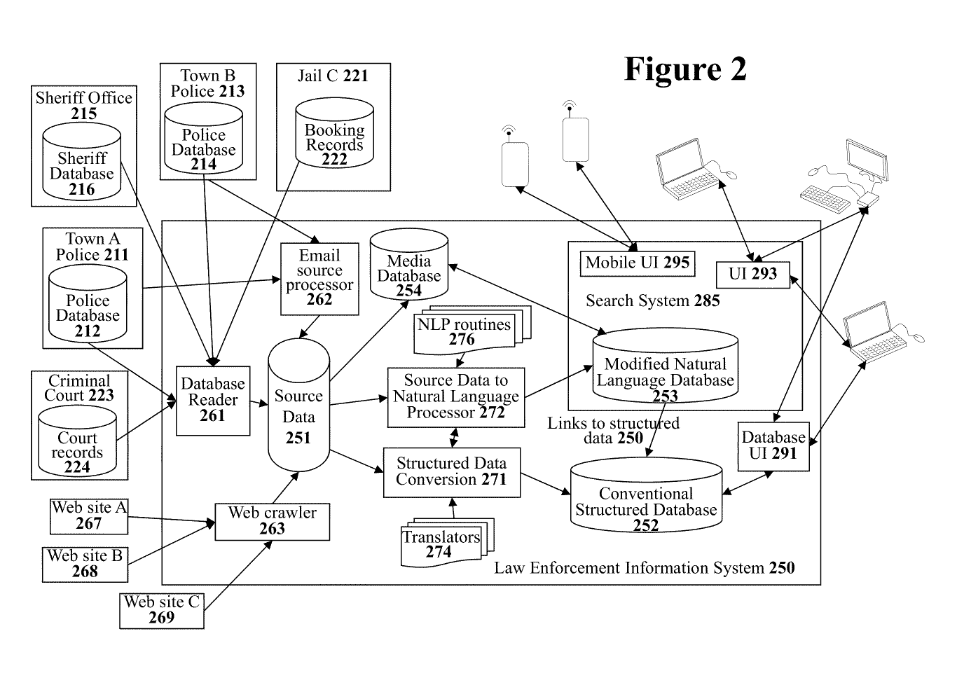

An ideal information technology system for law enforcement would collect information from all of the preceding sources and create a centralized source of crime related information. Furthermore, the system would make all of the crime related information available to law enforcement officers in an intuitive and easy to access manner. FIG. 2 illustrates an embodiment of a law enforcement information technology system specifically developed to achieve this goal.

Crime Information System Overview

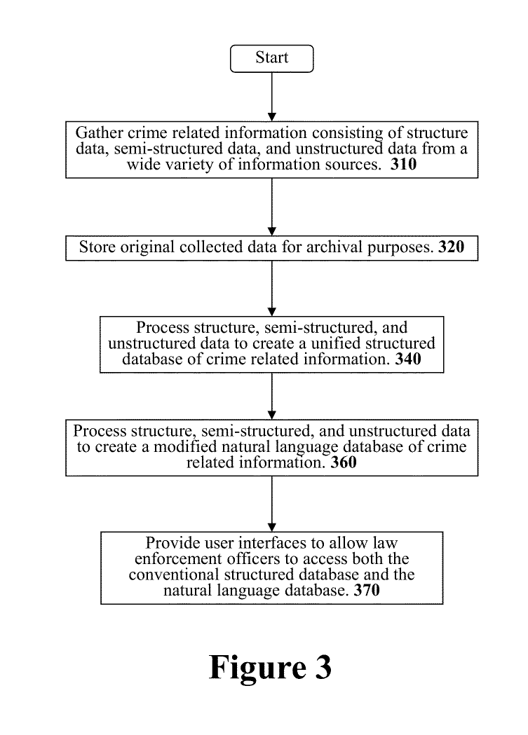

FIG. 2 illustrates a conceptual diagram of a law enforcement information system 250 designed to collect crime related information from many different information sources, process the information in a manner that improves search results, and make the crime related information available to authorized law enforcement personnel with intuitive user interfaces. This document section will set forth an overview of the law enforcement information system 250 disclosed in FIG. 2 with reference to the flow diagram of FIG. 3. Later sections of this document will describe various different modules of the law enforcement information system 250 and techniques used to implement those modules in greater detail.

The law enforcement information system 250 first collects crime related information from a wide variety of electronic sources as set forth in stage 310 of FIG. 3. The primary information collector is a database reader 261 that obtains crime related information from the Records Management Systems (RMS) of police stations, sheriff offices, and other agencies that maintain databases of crime related information. The database reader 261 may remotely access information as illustrated in FIG. 2 or may be implemented on site and periodically send updates to the law enforcement information system 250. In addition to the database reader 261, the law enforcement information system 250 may use other information gathering systems to collect crime related information. For example, an email processor 262 and a web crawler 263 may be used to collect information from police mailing lists and web sites, respectively.

At stage 320, the law enforcement information system 250 may store a copy of the information collected by the various data collection subsystems into a source data storage system 251 for archival purposes. The collected source data is processed by at least two different data processing systems to create two different processed databases that will be used by law enforcement personnel. Thus, as illustrated in the particular embodiment of FIG. 2, there are three different data repositories in law enforcement information system 250: the original unprocessed source database 251, a conventional structured database 252, and a modified natural language database 253.

Next, at stage 340 of FIG. 3, a structured data conversion processing system 271 converts received crime related information into structured data entries stored in a conventional structured database 252. A conventional database user interface 291 may be used to allow law enforcement personnel to access the conventional structured database 252.

Then, at stage 360 of FIG. 3, a source data to natural language processing system 272 converts collected crime related information into a modified natural language based database 253. The modified natural language database 253 may be created by converting original source data records into natural language records. The natural language data records are then provided to a search engine system that takes advantage of the large amount of natural language search tools that have been developed in recent years. Specifically, a search system 285 indexes the text of the created natural language data records to create an index that will greatly improve search performance. The search system 285 allows law enforcement personnel to enter keyword searches that use a standard internet search engine interface.

At stage 370, the law enforcement information system allows law enforcement officers to search the collected crime related information either using a conventional structured database user interface 291 or using an internet search engine type of user interface 293 and 295. The conventional database user interface 291 provides the law enforcement officers with a typical form-based search system that they have been trained to use. The addition of an internet search engine type of user interface (293 and 295) provides law enforcement officers with a much more user friendly interface that allows law enforcement personnel to enter keyword search terms and obtain very good search results with little training.

To fully describe the law enforcement information system 250 of FIGS. 2 and 3, various sub components of the law enforcement information system 250 will be described in detail in later sections of this document. Examples will be provided describing how various sub components of the law enforcement information system operate. Note that the various sub components may be implemented individually and combined with different components in various other embodiments.

Information Collection System

The core currency of the law enforcement information system 250 disclosed in FIG. 2 is the crime related information that can be used to help solve crimes and predict future crime problems. Thus, a fundamental set of components for the law enforcement information system 250 are the various data collection components. The data collection components collect crime related information from a wide variety of electronic information sources.

In order to collect as much crime related information as possible, the law enforcement information system 250 of FIG. 2 has been designed as an extensible system that allows for multiple different “plug-in” data collection systems. Each differently plug-in data collection system is designed to collect information from a different information source. When a new source of crime related information is identified or made available, a new plug-in data collection system may be created to collect information from that new source of crime related information.

The embodiment of FIG. 2 illustrates three different plug-in data collection systems: a database reader 261, an email processor 262, and a web crawler 263. However, many different plug-in data collection systems may be added to handle new sources of crime related information. Information from individual data files may also be added to the law enforcement information system 250 as necessary. A data file processor (not shown) may be used to extract information from common file formats such as word processor files, spreadsheets, raw text files, and other data sources that are commonly used to store information.

A primary source of crime related information will be police stations, sheriff offices, criminal courts, and other governmental agencies that deal with law enforcement. These agencies generally all maintain their own databases of crime-related information. FIG. 2 illustrates police station A 211 and police station B 213 that maintain police databases 212 and 214, respectively. Similarly, a Sheriff office 215 maintains a crime information database 216. Federal law enforcement agencies (not shown) may also make their databases available. In addition to the direct law enforcement agencies, supporting governmental agencies such as a criminal court 223 may make its court records 224 available to the law enforcement information system 250. Furthermore, a jail C 221 that processes detainees can make its booking records 224 available.

To collect information from all of these governmental databases, a database reader component 261 has been created. The database reader component 261 may be implemented in various different manners. For example, the database reader component 261 may periodically poll databases to obtain new records that have been created. Alternatively, the database reader component 261 may receive and process batches of data periodically sent by the records management systems at participating agencies. The database reader may be implemented in whole or in part at the various different governmental agencies.

Upon receiving a new record, the database reader component 261 stores a copy of the original record into a source data storage system 251. The source data storage system 251 stores a copy of all the different records received in an original format such that the original source data can be retrieved later as necessary. Various different types of media files that are received such as images, thumbnail images, audio recordings, videos, etc. may be stored in a separate media database 254. In particular, media files that are encoded in various different formats may be converted to commonly used formats and stored in media database 254. Storing media files in commonly used formats on a dedicated media database 254 allows such media files to be easily served later.

In one embodiment, the database reader component 261 has been programmed to handle a wide variety of different XML formats for storing crime related information. For example, the following different types of XML record formats are identified and handled:
GJXDM (“Global Justice XML Data Model”) 1.0, 2.0, 3.0.3 (2005)
NIEM 1.0 (2006) NIEM2.0 (2007) 2.1 (2009) (an outgrowth of GJXDM)
LEXS—extends subsets of NIEM
EDXL (DHS, EIC) “Emergency Data Exchange Language”
Various local law enforcement XMLs that are extensions to NIEM

In addition to the main database reader component 261, the law enforcement information system 250 may be supplemented with many additional plug-in collection systems that may be created as necessary to support additional sources of crime related information. In the embodiment of FIG. 2, an email processor 262 and a web crawler 263 plug-in collection systems have been added to collect additional crime related information.

Many law enforcement agencies operate a local mailing list wherein law enforcement officers may share information via email messages to the local mailing list. To keep track of this shared information, an email processor 262 may be added to the email list such that it receives each new email message sent to the mailing list. The email processor 262 plug-in captures email messages sent to the local mailing list and stores a copy of each message into the source data storage system 251.

The World Wide Web of the internet has become populated with many social networking sites wherein people can easily post images, post videos, and share stories. Many criminal suspects use such social networking sites and thus self-disclose significant amounts of useful information about themselves. To take advantage of such information, the law enforcement information system 250 may include a web crawler 263 to collect information from selected internet web sites.

The web crawler 263 plug-in may collect information from designated web sites and store the collected information in to the source data storage system 251. The web crawler 263 may label the information collected from designated web sites based upon why that information was collected. For example, if gang members communicate with each other using a particular web site being crawled then all of the web pages collected from that web site may be labeled with a gang name identifier for that particular gang.

Another web based source of information that may be quite useful to law enforcement is local news web sites. Crime is generally a news-worthy topic such that local news reporters tend to cover any significant local crime story. The local news reporters writing stories may collect some valuable information that was not collected during police investigations. Thus having the web crawler 263 read in local crime news stories can add to the information available to law enforcement officers.

Many additional “plug-in” data collection systems may be added to the law enforcement information system 250 as necessary. Various third party data collectors may collect valuable data that can easily be added to the law enforcement information system 250. For example, a data collection service may collect license plate images of cars parked at various locations and store that information. That information may be added to the law enforcement information system 250 to help provide the location of cars.

For some small cities, the crime related information may simply be stored in a folder of Microsoft word documents. Such records can be handled by treating the Microsoft word document as semi-structured data wherein the filename and other properties associated with the Microsoft word document provide some structure but the main content of the Microsoft word document is treated as a narrative text field.

Structured Data Processing System

As set forth in the previous section, the law enforcement information system 250 collects a vast amount of crime related information. To allow law enforcement officers to effectively use the collected crime related information, the law enforcement information system 250 creates two different processed databases of the crime related information: a conventional structured database 252 and a modified natural language based database 253. This document section describes the creation of the conventional structured database 252.

Law enforcement agencies have long maintained structured databases containing collected crime related information. However, since there are a wide variety of different law enforcement agencies in the United States (Local police stations, sheriff offices, Federal agencies, etc.), there are also a wide variety of different database structures. Over the years, there has been some attempt to reconcile the different types of database schema but there remain multiple different database schemas that different law enforcement offices use. To handle all different database schema used at different law enforcement agencies and handle new data, the conventional structured database 252 uses a broad database schema that may accommodate all of the different databases systems that provide source information.

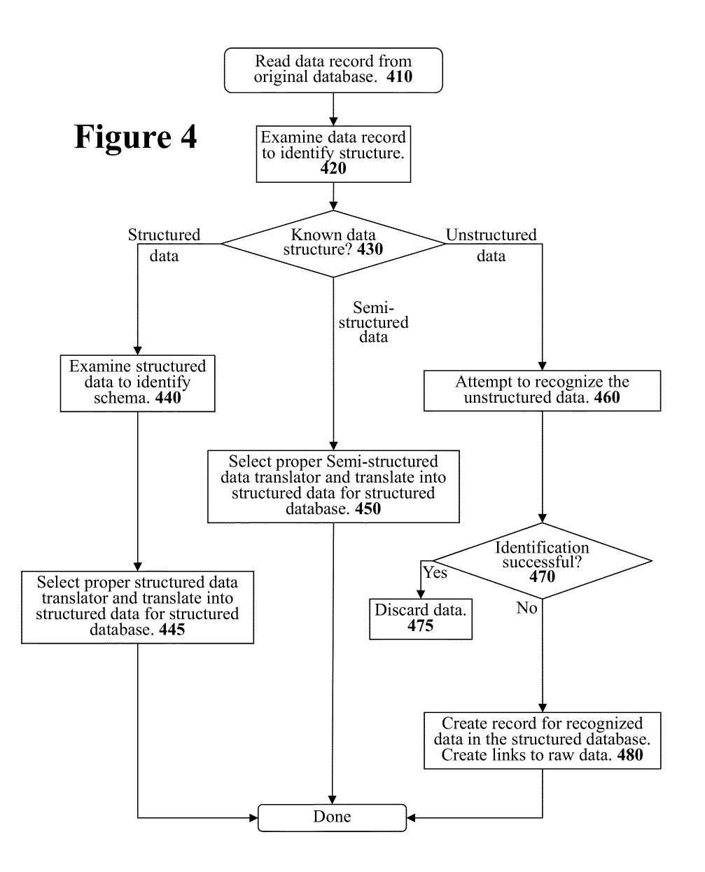

To create the conventional structured database 252 for the law enforcement information system 250, a structured data conversion system 271 reads data records from the source data storage system 251, processes those data records as required, and stores the processed data records into the conventional structured database 252. FIG. 4 illustrates a flow diagram describing the operation of one possible structured data conversion system 271.

Referring to FIG. 4, the structured data conversion system 271 reads a data record from the source data storage system 251 at stage 410. The structured data conversion system then examines the data record at stage 420 to identify the structure of the data record. The structured data conversion system then proceeds from stage 430 depending on the type of data structure identified.

For well-structured data, such as database records obtained from the records management system of a law enforcement agency (such as XML records or database tables), the structured data conversion system will proceed to stage 440. At stage 440, the structured data conversion system examines structured data record to identify the specific data schema used by the data record. The structured data conversion system then selects a data proper translator 274 at stage 445 to translate the original data record into a new structured data record in the harmonized structured database 252 of the law enforcement information system 250 that has been created to handle structured records from any agency that collects crime related information.

Depending on the implementation, some information from the original source data record may be discarded during this conversion process. However, the discarded information will still reside within the source data storage system 251 and in the original database where the data record was retrieved from. A link to the original data record may be inserted such that original record can be retrieved if necessary.

Referring back to stage 430, when a semi-structured data record is received then the structured data conversion system proceeds to stage 450. An example of a semi-structured data record could be an email message received by email source processor 262. An email message includes identifiable structure such as the name of the person that wrote the email message, the date it was sent, the identity of the particular group that runs the email list, and the raw text in the email message.

The structured data conversion system may handle such a semi-structured data record by selecting a proper data translation routine for the record and then processing the semi-structure data record with the selected data translation routine. The data translation routine converts the semi-structure data record into a structured data record stored within the conventional structured database 252. For example, an email message from a mailing list may be converted into an informal crime report for the date specified by the email message.

Referring back to stage 430, when an unstructured data record is received then the structured data conversion system 271 proceeds to stages 460 and 470 where it attempts to recognize at least some useful information from the unstructured data record. For example, a web page that was captured from a web site frequented by a particular gang may be labeled with the gang's name. If some useful information is recognized, the structured data conversion system 271 may create an appropriate structured database record at stage 480. If absolutely no useful information is recognized from the unstructured data record then the unstructured data record may be discarded at stage 475. However, the unstructured data will not be completely discarded since that unstructured data record will be kept in the source data storage system 251 and, more importantly, will be stored into the modified natural language based database 253 that will be described in the next section of this document.

By combining crime related information from many different sources, the structured data conversion system 271 creates a very large unified conventional structured database 252. Specifically, the conventional structured database 252 combines the information collected by many different government agencies that collect crime related information such as police station A 211, police station B 213, Sheriff Office 215, etc. Thus, a single search of the structured database 252 provides results information from many different law enforcement databases. If any data was discarded during the conversion process, a link may be provided back to the original record in either the source data storage system 251 or the original agency database that provided source information for the data record.

A conventional database user interface 291 may be created for the unified conventional structured database 252. The conventional criminal database user interface 291 may be created to appear very similar to the user interfaces typically used by the local agency databases such as police database 212 and 214. Thus, the conventional database user interface 291 allows officers that are familiar with standard law enforcement databases to easily search the much larger amount of crime related information stored within the unified conventional structured database 252.

The conventional database user interface 291 provides law enforcement officers with a very familiar database tool that can be used to access the large combined set of crime related information in conventional structured database 252. Although such a conventional interface allows trained officers with large amounts of experience working with such conventional databases to access more crime related information than before, many officers have expressed dissatisfaction with such conventional database tools. Conventional database interfaces generally involve marking checkboxes and filling in various fields in order to obtain specific data with a well-formed database query. But law enforcement work generally involves working with very incomplete information. Thus, numerous different search permutations may need to be entered into the conventional database user interface in order to find all of the relevant records that contain incomplete information.

Even when a skilled user is using a conventional structured crime database, the most relevant records do not always appear in the search results. The reason for this is that many data entry jobs are not performed completely such that not all of the different structured data fields are used properly. Thus, much of the most important information related to a crime report will end up in a single large text narrative field. If query entered into the user interface requests information using the proper structured data field but that information was only available in the narrative field and not placed in the proper structured field then a relevant record may not easily be found.

Due to the ubiquity of the global internet, all law enforcement officers now have experience in working with a conventional internet search engine used to locate relevant web sites. The internet search engines use sophisticated results ranking systems in attempts to rank the most relevant documents even if those documents have incomplete information.

To take advantage of the intuitive interface of internet search engines and the powerful document ranking systems that such internet search engines use, the law enforcement information system 250 of the present disclosure has implemented an entire parallel database and database interface system that operates using the teachings of internet search engines. Specifically, the following section describes the creation of a modified natural language database 253 that allows law enforcement officers to search a vast combined repository of crime related information using an intuitive user interface that operates very much like a typical internet search engine.

Modified Natural Language Data Processing System

Referring back to FIG. 2, in addition to creating a conventional structured database 252 that combines crime related information from many different sources, the law enforcement information system 250 also creates a modified natural language database 253 to store the crime related information. The modified natural language database 253 operates on crime related data records created in a modified natural language format such that many advanced techniques for searching text documents and ranking the most relevant search results can be effectively applied to entire collection crime related information.

In one embodiment, the modified natural language database 253 conceptually stores data records as documents wherein each document can have multiple different fields of data. In one embodiment, different data fields are used to store information that is deemed to have different importance levels. Thus, when subsequent keyword searches are performed the data records that have matches in the more important text fields are ranked higher in the search results than data records that only have matches in the less important fields.

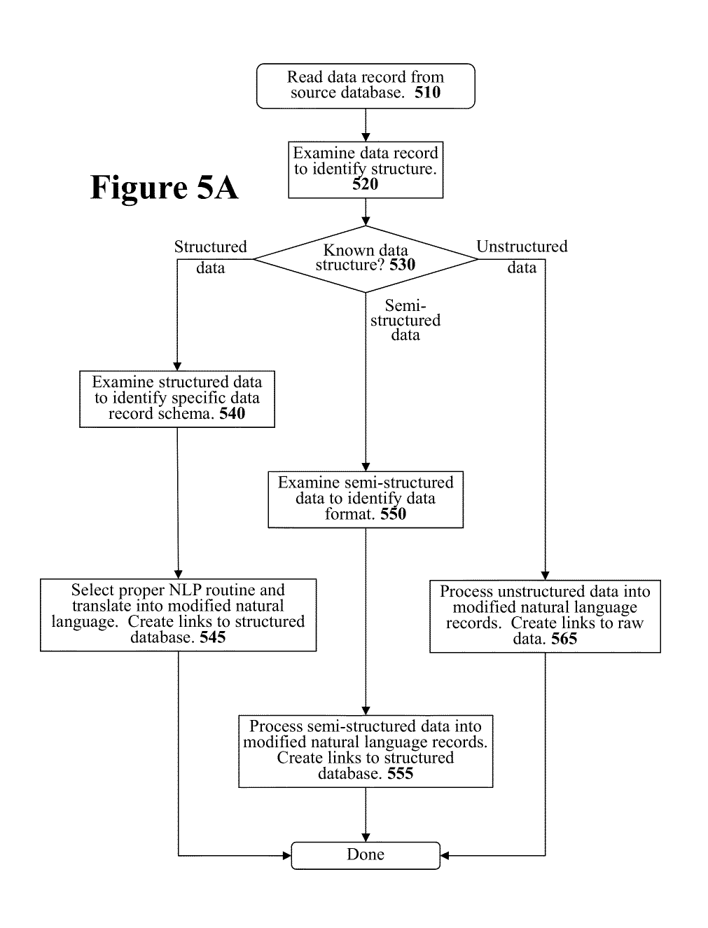

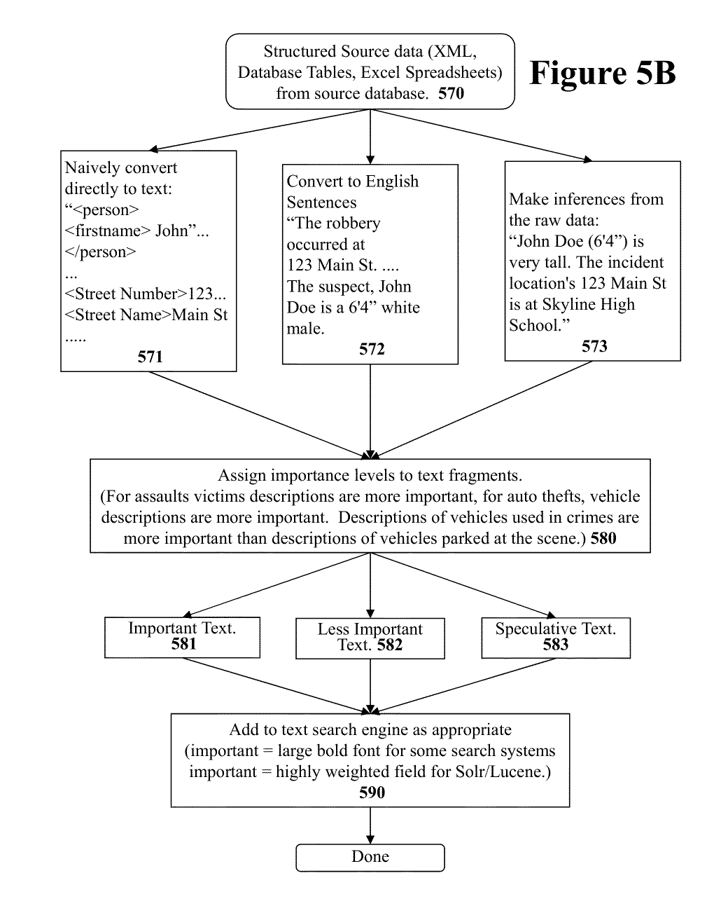

Referring to the FIG. 2, a source data to natural language processor system 272 processes data records from the source data storage system 251 into natural language documents stored in the modified natural language database 253. The source data to natural language processor system 272 may be supplemented by many custom natural language processing (NLP) routines 276 that have been created to handle specific types of source data records. Furthermore, many speculative inferences may be made from the source data records and added into the modified natural language document being created. The speculative inferences can greatly improve the ability to identify relevant documents that would be unlikely to turn up using the traditional structured database 252. FIG. 5A illustrates a flow diagram generally describing how a source data records may be processed into modified natural language documents in one embodiment.

At the top of FIG. 5A, the source data to natural language processor system reads a data record from the original data store at stage 510. The source data to natural language processor system then examines the data record at stages 520 and 530 to determine how the data record will be processed.

When a structured data record is received the system proceeds to stage 540. Structured data records include XML formatted data records, database tables, and any other well-structured data formats. At stage 540, the system examines the structured data record to identify the specific schema used to encode the structured data record. For example, the system may determine that the structured record is an XML formatted arrest record. Then, at stage 545, the system selects the proper natural language processing (NLP) routine 276 to process the structured data record into a natural language record. Various ‘scripts’ may be used to translate a structured XML record into natural language record that reflects the same information.

FIG. 5B illustrates a conceptual diagram describing one method of processing a structured (or semi-structured) source data record into a natural language data record. At the top stage 570, the system receives some type of structured (or semi-structured) source data record such as an XML document, a set of database tables, an excel spreadsheet, a word processing document, etc. The system may then create three different text versions of the source data record.

A first version is a naïve conversion 571 of the original source data record into text such as a set of tables read from a database or a verbatim XML document. The text version of the original source data is used to ensure that all of the original source data is included in the final natural language record being created.

A second version is a translation of the source data record into natural language sentences 572. The natural language sentences may be created from scripts wherein data extracted from the source data record are inserted into the script. The natural language sentences serve as excellent source material to be fed into search engines.

The third version is a set of rational inferences drawn from the source data record written in natural language 573. The rational inferences drawn from the source data will expand the set of keyword search terms that can be used to locate the record.

After creating the three text sections 571, 572, and 573, the text fragments are then assigned importance levels. Such information prioritizing may be performed in a context sensitive basis. For example, crime incident records for an auto theft and a sexual assault may both contain a detailed description of a car and a detailed description of a victim. However, this information is certainly not equally important in the two very different criminal cases. Thus, for the auto theft data record the description for the stolen car may be assigned as important text 581 and a description of the victim may be deemed as less important text 582. Conversely, in the sexual assault data record the description of the victim may be assigned as important text 581 and the description of the car may be deemed as less important text 582. Similarly, information about an arrestee or suspect in a record may be assigned as important text 581 and information about witnesses or bystanders may be assigned to be less important text 582. Active warrants should be marked as having higher priority than inactive warrants. Many of the more speculative inferences 573 generated may be assigned as speculative text 583.

The text in the natural language data record is then created at stage 590 in a manner which delineates the different levels of importance assigned to the different text. In an embodiment that uses the Apache Lucene/Solr project, the different levels of text importance are assigned to different labeled fields within the natural language document. In other search engines the important text may be created in a large bold font. The different levels of text importance can be used both to filter documents and the help ensure that more relevant documents may receive higher relevance rankings during searches. The final natural language database record may include the naïve text conversion 571, the natural language conversion 572, and the rational inference conversion 573 wherein different sections of text are marked within importance levels as appropriate.

To best illustrate the process of translating a structured data record into natural language text for a natural language record, an example of processing an XML formatted data record is hereby provided. Note that this example has been simplified in order to illustrate the concept. The following well-structured XML data record represents a portion of a suspect arrest record stored in a structured format:

TABLE 1
XML Arrest Record

```
<?xml version=“1.0” encoding=“UTF-8”?>
<SomeXMLContainer>
[... hundreds more lines...]
<Incident>
<nc:ActivityDate>
      <nc:DateTime>2007-01-01T10:00:00</nc:DateTime>
      </nc:ActivityDate>
      </Incident>
      [... hundreds more lines...]
      <tx:SubjectPerson s:id=“Subject_id”>
      <nc:PersonBirthDate>
      <nc:Date>1990-01-01</nc:Date>
      </nc:PersonBirthDate>
      <nc:PersonEthnicityCode>N</nc:PersonEthnicityCode>
      <nc:PersonEyeColorCode>BLU</nc:PersonEyeColorCode>
      <nc:PersonHeightMeasure>
      <nc:MeasurePointValue>604</nc:MeasurePointValue>
      </nc:PersonHeightMeasure>
      <nc:PersonName>
      <nc:PersonGivenName>Jonathan</nc:PersonGivenName>
      <nc:PersonMiddleName>William</nc:PersonMiddleName>
      <nc:PersonSurName>Doe</nc:PersonSurName>
      <nc:PersonNameSuffixText>III</nc:PersonNameSuffixText>
      </nc:PersonName>
      <nc:PersonPhysicalFeature>
      <nc:PhysicalFeatureDescriptionText>Green Dragon Tattoo
      </nc:PhysicalFeatureDescriptionText>
      <nc:PhysicalFeatureLocationText>Arm</
      nc:PhysicalFeatureLocationText>
      </nc:PersonPhysicalFeature>
      <nc:PersonRaceCode>W</nc:PersonRaceCode>
      <nc:PersonSexCode>M</nc:PersonSexCode>
      <nc:PersonSkinToneCode>RUD</nc:PersonSkinToneCode>
      <nc:PersonHairColorCode>RED</nc:PersonHairColorCode>
      <nc:PersonWeightMeasure>
      <nc:MeasurePointValue>150</nc:MeasurePointValue>
      </nc:PersonWeightMeasure>
      [... dozens more lines of xml about the person ...]
      </tx:SubjectPerson>
      [... hundreds more lines of xml...]
      <tx:Location s:id=“Subjects_Home_id”>
      <nc:LocationAddress>
      <nc:AddressFullText>1 Main St</nc:AddressFullText>
      <nc:StructuredAddress>
      <nc:LocationCityName>Dallas</nc:LocationCityName>
      <nc:LocationStateName>Texas</nc:LocationStateName>
      <nc:LocationCountryName>USA</nc:LocationCountryName>
      <nc:LocationPostalCode>54321</nc:LocationPostalCode>
      </nc:StructuredAddress>
      </nc:LocationAddress>
```

The preceding portion of an XML formatted arrest record contains a large amount of detailed information about a particular arrested suspect named Jonathan Doe. When the information from this XML formatted arrest record is stored in a structured database, the arrest record can easily be accessed by entering a properly formatted database query that explicitly specifies some matching data in the arrest record. However, if a user would like to find this arrest record using a simple keyword type of search, it may be very difficult to locate this arrest record if used as is in its current form alone. For example, if a user typed “Johnnie Doe” into a keyword search engine, the record would be unlikely to be retrieved since the suspect's name is listed as “Jonathan”. Even if a user typed “Jonathan Doe” into a keyword search engine, the a typical search engine might not produce this record high in the search results since “Jonathan” and “Doe” are separated by the XML tags and his middle name such that the document would be ranked low. Thus, although XML formatted records are great for conventional structured databases, XML formatted records are actually very poor source material for text search engine systems.

Internet search engines are generally tuned to locate relevant web pages and other documents that largely contain natural language information. Thus, to improve the ability to local relevant records with a single-field keyword search system, the system of the present disclosure converts structured database records (XML records, database tables, etc.) such as the preceding arrest record into natural language.

For example, the system of the present disclosure may translate the bolded portions of the preceding XML arrest record into a modified natural language document that includes the following synthesized text:

TABLE 2
Arrest Record Synthetic Text

<Arrest Record>
<Field=Important_Text>
Jonathan Doe, a tall (6′4″) red haired blue eyed teen (17 years old)
white male of Dallas TX was arrested at 1 Main St on January 1.
</Field=Important_Text>
<Field=Speculative_Text>
Possible nicknames Johnny, John, Bill, Billy
</Field=Important_Text>
<Arrest Record>

The synthetic natural language text listed in Table 2 contains several salient facts from the arrest record of Table 1 that have been translated into a natural language narrative using an arrest record script. In this particular embodiment, the document is divided into separate fields that are recognized by a search engine system and treated differently. An “important text” field has been used to store a simple natural language narrative containing many of the important facts of the arrest event. Thus, a search for “Jonathan Doe” into a search engine based system would identify this record and rank it highly since “Jonathan” and “Doe” are adjacent to each other in the important text field. Synthetically creating a natural language narrative from the XML record greatly improves the search results that will be provide by a typical search engine system. Note that for completeness, both the original XML text from Table 1 and the natural language version from Table 2 may be placed into a natural language document that is placed in a natural language database and submitted to a search engine system.

The synthetic natural language text for the arrest record listed in Table 2 also includes a second field referred to as the “speculative text” field. The system of the present disclosure may create such a “speculative text” field as a place to add inferred text items that may help in locating this document at times when it is relevant. For example, in this case the arrestee's first and middle names are “Jonathan” and “William”. Many people use their middle name instead of their first name and long formal names are often shortened such that the processing system has added a speculative text field that includes the possible nicknames “Johnny, Johnnie, John, Bill, Billy”. Thus, when a user performs a search using one of those names, this record may be produced in the results even though those names were not in the original arrest record. For example, if a user typed “Johnnie Doe” into a search engine based system then this record would appear somewhere in the results.

Rational inferences do not have to be limited to the speculative text field. In the case of the preceding arrest record example, the arrestee has a height of six foot and four inches (6′4″). A person with a height of six foot and four inches is generally agreed upon to be a “tall” person since that is above the average height for a male. Thus the adjective “tall” had been added to the natural language narrative of the arrest within the important text field. Such rational inference based labeling of data records is a very important aspect of the natural language processing system of the present disclosure and thus a later section of this document discusses inference based text synthesis in greater detail.

The ability to create natural language data records from structured (or semi-structured) is a very important component of the disclosed law enforcement information system. To further illustrate the process of translating a structured data record into a natural language record, a second example is hereby provided wherein a set of data from database tables is translated into a natural language narrative for a crime report. The following data table entries from structured database may be read by the source data to natural language processor system 272 for a new record:

TABLE 3
Incident Report Database Tables
Incident_Table:

| Incident ID | Date | Location ID | [ . . . many more fields . . . ] |
|---|---|---|---|
| 1 | 2012-01-01 | 1111 | |
| | 07:30:00 | | |

Person table:

| Person ID | First Name | Last Name | Middle Name | Race | Sex | DOB | Hair color |
|---|---|---|---|---|---|---|---|
| 11 | Jonathan | Doe | William | W | M | 1995-01-01 | Dark blond |
| . . . | . . . | . . . | . . . | | | | |
| 99 | Jane | Smith | William | V | F | 1997-01-01 | |

Vehicle Table:

| Vehicle ID | MAKE | Model | Year | Color | Plate | Vin |
|---|---|---|---|---|---|---|
| 111 | FORD | EXP | 2011 | Cyan | | 1FMZU73E04ZA01234DPU06V6 |

Location table:

| Location ID | Latitude | Longitude | Street Address | City | State |
|---|---|---|---|---|---|
| 1111 | 37.8013 | −122.16391 | 12250 Skyline | Oakland | CA |
| | | | Boulevard | | |

Person Incident Relationship table:

| Person ID | Incident ID | Relationship |
|---|---|---|
| 11 | 1 | Subject |
| 11 | 1 | Arrestee |
| 99 | 1 | Victim |

Vehicle Incident Relationship table:

| Vehicle ID | Incident ID | Relationship |
|---|---|---|
| 111 | 1 | Used in |
| | | Crime |

Incident Property table:

| | | | | Serial | |
|---|---|---|---|---|---|
| Incident ID | Relationship | Make | Model | Number | Desc |
| 1 | Weapon | Glock | 19 | | |
| | Used in | | | | |
| | Crime | | | | |
| 1 | Stolen | Apple | Iphone | | 555-1212 |
| 1 | Stolen | | | | Gold Chain |
| | | | | | Necklace |
| 1 | Suspect | | | | Red baseball |
| | Clothing | | | | cap |
| 1 | Suspect | | | | Black leather |
| | Clothing | | | | jacket |

Gang Person table:

| Person ID | Gang Name | Affiliation |
|---|---|---|
| 11 | Main St XIV | Admitted |
| | | member |

The preceding data tables describe an entire criminal incident including the location, the time, the people involved, a vehicle involved, and property involved. Again, a skilled user of a traditional structured database could locate the record easily using a properly structured database query. However, it would be very desirable to have that criminal incident record appear in search results if a user types several keywords from that crime incident into a general search engine. To allow that crime incident record to appear in search results, the system of the present disclosure converts the crime incident record into a natural language narrative. Thus, the source data to natural language processor system 272 may read the preceding database tables from a structured database and produce the following natural language narrative:

TABLE 4
Incident Report Synthetic Text

```
<Field=“Important Text”>
    Jonathan William Doe, a 6′4″ red haired blue eyed white male born 1995-01-01 of Dallas
Texas is the subject of an investigation for an Armed Robbery at 12250 Skyline Boulevard,
Oakland, CA at 18:30 on January 1, 2012. He was wearing a red baseball cap and a black leather
jacket and was holding a Glock 17. He is an admitted member of the Main St XIV gang. A 2011
Cyan Ford Explorer, with VIN number 1FMZU73E04ZA01234DPU06V6 was reported as being
used in the crime. An iPhone with phone number 555-1212 and a gold chain was stolen in the
robbery. The victim Jane Smith is a Vietnamese female born 1997-01-01.
</Field>
<Field=“Speculative text”>
    The subject Jonathan William Doe is very tall (6′4″ for a 17 year old male) white male, and 17
years old at the date of the incident. Possible nicknames include John, Johnny, Will, Bill, Billy. The
Main St XIV gang is a Norteno gang, and a mostly Hispanic gang. A red baseball cap may be
described as a red hat. A Glock 17 is a black 9mm handgun, a semiautomatic (semi-auto) weapon,
a pistol. A Ford Explorer is a SUV (Sport Utility Vehicle). A Cyan car can look Blue or Green.
VIN Number 1FMZU73E04ZA01234DPU06V6 suggests it is a 4-door (4DR) SUV”.
    The victim Jane Smith, an Asian (Vietnamese) female, with dark blond hair (similar to light
brown hair) was 15 years old at the date of the crime. An iPhone is a cell phone. Since the phone
was from Oakland, the phone number 555-1212 is probably 510-555-1212 A gold chain is
Jewelry.
    The incident location 12250 Skyline Boulevard, Oakland, CA is at Skyline High School, in the
Oakland Unified School District, in City Council District 1, in Alameda County CA. The
latitude/longitude 37.8013, −122.1639 is inside the cafeteria at Skyline High School.
    The incident date Jan 1 2012 (Saturday January First, 2012; 2012-01-01; 1/1/2012) is a
weekend day, and a holiday (New Year's Day). The weather was rainy on the incident date in
Oakland CA. The time of the incident (07:30, or 7:30am) is early morning, around sunrise on that
date.
    Armed Robbery is a Violent Crime and a UCR Part 1 Crime.
</Field>
```

In the preceding synthesized natural language data record, the “important text” field describes the entire criminal incident in a natural language form. The important text field contains a narrative of the incident using the actual data from the database tables. The “speculative text” field contains a large number of speculative inferences that greatly expands the keywords that can be used to help find this particular criminal incident when it is relevant. The speculative text field adds a large number of synonyms (A red baseball cap may be described as a red hat), additional information on known gangs (Main St XIV gang is a Norteno gang, and a mostly Hispanic gang), generalizations (Vietnamese is generalized to Asian, gold chain is generalized to jewelry), detailed information on the weapon (A Glock 17 is a black 9 mm handgun, a semiautomatic (semi-auto) weapon, a pistol), possible alternate names (John, Johnny, Will, Bill, Billy), additional information obtained by look-up (The weather was rainy on the incident date in Oakland Calif.), etc.

The speculative text allows this record to be easily located when the following searches are entered into a search system:
“Semi-auto handgun at Skyline High”
“Johnny Doe very tall teen with green SUV”
“Jewelry robbery in the rain”
“Holiday weekend early morning robbery”
“Asian teen cell phone robbery victim”

This particular record will be located using those searches even though none of the words “semi-auto”, “jewelry”, “rain”, “skyline high”, “green”, “SUV”, “holiday”, “early morning”, “Asian”, “510-593-6934”, nor “cell phone” appeared in the original source data record. The technique of synthesizing speculative text in the form of a natural language narrative has proven to be an excellent manner to help search engines locate such a relevant record. The technique of synthesizing natural language narratives works much better than merely tagging a record with a set of related keywords since search engines are designed to look for context, identify grammar, identify adjective-noun phrases, and use many other techniques to find the best search results.

Referring back stage 530 of FIG. 5A, when semi-structured data records are processed the system proceeds to stage 550 to examine the semi-structured data to identify the data format. Next, at stage 555, the system then processes the semi-structured data record into a modified natural language record for the modified natural language database 253 in a manner similar to how structured data records are processed. Thus, the same techniques disclosed in FIG. 5B may be used when processing semi-structured data records.

The amount of processing performed on a semi-structured data record will depend on the source material. If there is a fair amount of structure then full conversions such as two preceding examples wherein a fair amount of speculative text may be added. In other cases, the raw semi-structured text may suffice. For example, an email message from a mailing list already contains a natural language narrative written by the author of the email message such that not much additional processing may be required.

However, in one embodiment, an entity extraction tool is used to extract structured data from the unstructured email message. The extracted structured data may then be used to synthesize additional speculative text that can locate the email message in situations where it may be relevant even though the exact keywords are not located in the original email message. For example, an email message may mention an incident with a member of the Nortenos gang. The entity extraction tool may identify the name of the “Nortenos” as a gang and add speculative text such as “The Nortenos is a Hispanic gang” such that a search for “Hispanic gang” would locate this email message. This non-intuitive system of extracting data structure from unstructured data, generating rational inferences from the extracted structured data, and then synthesizing natural language text for use in a text search engine has proven very effective for locating relevant records with an easy to use search system.

Referring again back stage 530 of FIG. 5A, when an unstructured data record is received the system proceeds to stage 565 to process the unstructured data record. Unlike the conventional structured database 252, the modified natural language database 253 can handle any unstructured data consisting of natural text. If some of the data in the unstructured record is recognized, then the system may be able to apply some of the NLP routines 276 to the unstructured data. As with semi-structured data, an entity extraction tool may be used to identify information from an unstructured record. The extracted structured data may then be used to create natural language narratives. Furthermore, rational inferences may be made from the extracted structured data. Then speculative text may be synthesized from the rational inferences. For example, if the web crawler 269 grabbed a web page from a gang's web site, the web crawler 269 may tag the web page with the gang's name. An entity extraction tool may then identify the gang's name and extract the gang's name as structured data. Finally, the natural language processing system may synthesize some text that is added to the web page that describes information known about that particular gang such as the gang's name and where they operate. Thus, when a search is performed that includes the gang's name and some of the phrases in the web page then that web page record will appear in the results.

Even in the instances when nothing can be automatically recognized or extracted from the unstructured data, an unstructured data record can still be used to create a record in the modified natural language database 253 by simply creating a data record with the raw unstructured text in it. Thus, unlike the structured database system 252 the modified natural language database 252 can always use any text.

Natural Language Data Record Creation Heuristics

As set forth in the previous section, the natural language data records created for the modified natural language database 253 are going to be processed by a text processing system of a search engine, searched using keyword searches, and then the results will be ranked according to a document ranking system. In order to provide the most relevant results to law enforcement officers, the natural language data records should be created in a manner that helps ensure that the most relevant documents will be ranked highly. Thus, the manner in which the natural language data records are created should take into consideration how the document ranking system of the search engine being used operates. This section describes various techniques used to guide the creation of natural language data records to obtain the best results.

Keyword Density—Many search engines rank documents higher if they contain a higher density of the entered keywords since this indicates that the document really does discuss the topic of that keyword. Thus, certain important keyword phrases may be repeated in a synthetically created keyword narrative to boost the ranking of the document. For example, in the incident report synthetic text of Table 4, the name “Jonathan William Doe” is listed twice and several alternatives for the name Jonathan are listed. A search engine that performs stemming and uses keyword density would rank this report higher and that is a good result since a suspect name is an important keyword. Some search engines will reduce the document ranking for documents that contain too many references to the same keywords since those documents may simply be “keyword spamming” in a crude attempt to gain hits.

Proximity Context Detection—Many search engines consider the context of keywords in relation to each other. Documents with keywords in the same paragraph may be ranked higher, documents with keywords in the same sentence will be ranked even higher, and documents with keywords adjacent to each other will be ranked very high. Thus, the organization of the text in the synthesized documents is important. In the incident report synthetic text of Table 4, information regarding each separate entity (person, place, or thing) is organized into separate sections of text where the most related terms are closest to each other. In the synthetic text of Table 4, the first paragraph of speculative text describes the subject of the investigation and his weapon, the second paragraph describes the victim and the stolen property, the third paragraph describes the incident location, and the fourth paragraph provides more detail on the time of the incident. This style of carefully laying out the description in different paragraphs complements context sensitive search algorithms that use attributes of the text including proximity of words, and grammar (adjective/noun clauses) to help rank search results. For example, with most text search engines the preceding synthesized document will rank quite high for a search for “Jane Smith's Iphone” because iPhone and Jane Smith mentioned in the same paragraph. It will also rank quite high for “very tall 17 year old white male” because all of those adjectives describe the same noun in a sentence.

Word Distance—Many search engines consider the distance between keywords in determine the ranking of search results. Thus, as set forth in the previous paragraph in context detection, it is important to place related words close to each other. In one embodiment, the search engine has been modified to go beyond this. In one embodiment, the indexing system identifies related clauses and reduces the perceived space between the words in those clauses. Similarly, the system may recognize unrelated clauses and increase the word spacing between those unrelated clauses. For example, an arrest record may state “The suspect Johnny was wearing a red baseball cap and black leather jacket.” In that sentence ‘red baseball cap’ and ‘black leather jacket’ are independent clauses. Thus, the indexing system may insert virtual word spaces between the independent clauses ‘red baseball cap’ and ‘black leather jacket’ such that a search for ‘black baseball cap’ does not rank highly even though those words are close together in the sentence sub section stating “baseball cap and black”. Similarly, the virtual word spaces in the same clause may be reduced to improve rankings. For example, the word space between ‘black’ and ‘jacket’ may be reduced such that a search for ‘black jacket’ will rank this document very highly even though the original text states ‘black leather jacket’.

Text Formatting—Many search engines consider the specific text formatting to help rank search results. For example, if the keywords are found in sections of larger font size text, bold text, underlined text, colored text, or other special text formatting then those documents may be ranked higher. Thus, the synthetically generated text sections may use this feature to boost certain important words and phrases. For example, the suspect's name may be placed in a larger text font if the search engine considers larger text more important. Note that different search engines use different systems of identifying such important text such that synthetically generated text may be tuned to output different text depending on which search engine technology will be used for indexing and searching the documents.

Link Popularity—It is well known that many internet search engines consider the number of links pointing to a particular web page to help determine the importance of a particular web page. Thus, if a very large number of other web pages point to a particular web page then that web page will rank much higher in the search results. This may initially seem useless for a closed system used to search law enforcement documents. However, by intentionally inserting links into related documents, this feature can be taken advantage of Various different pieces of information link different crimes, suspects, gangs. For example, phone numbers, license plate numbers, gang names, and other information appear many times in different documents. By inserting links when such repeated information is found in different documents, a search engine for can rank results for documents in a law enforcement information system by considering the number of links to other documents.

Word Context—Many different words have different meanings depending on the context that the words are used within. For example, the word “Java” may refer to coffee, a well-known programming language, or an island in the South Pacific Ocean. When a word is placed within proper context that helps identify the specific intended usage of the word, the task of identifying relevant documents with that keyword is simplified for search engines that consider word context. The system of the present disclosure synthetically generates text that adds proper context to words to help identify the words properly. For example, a wilderness explorer may ford a river to cross it. However, a document that mentions an “explorer fording a river” is completely irrelevant to solving a crime involving a Ford Explorer. The synthetic text of Table 4 mentions that “A Ford Explorer is a SUV (Sport Utility Vehicle).” This not only helps locate this record if a search uses the keyword ‘SUV’ but it also helps place ‘Ford Explorer’ into the context of a ‘Sport Utility Vehicle’ so that it is clear that the vehicle is being discussed instead of a river explorer.

Improving Records Using Rational Inferences

As set forth earlier, the system of the present disclosure can significantly improve the usefulness of the data stored in the modified natural language database 253 by making rational inferences and then synthesizing natural language text resulting from the rational inferences that can be added to the data records. Many of the inferences will be very straightforward and logical but other inferences may be more speculative. To separate the importance of the different types of inferences, the indisputable (or at least very high probability) logical inferences can be placed into the important text fields and the more speculative inferences can be placed in a speculative text field. Various different levels of text field importance may be used such as verbatim text from raw XML, important natural language translation text fields, rational inference fields, and speculative inference fields.

A wide variety of different types of rational inferences may be made and used to supplement data records. This section of the document will describe some of the inferences that have been made.

Humans talk about time using a variety of language such that supplementing data records with additional time information may improve search results. Dates are often written in a month-day-year format or a year-month-day format (or in a day-month-year format in Europe). To clarify this ambiguity, an inference system may add text to ensure that a record will be found as long as the user enters any of those forms. For example, the speculative text of Table 4 specified “The incident date Jan 1 2012 (Saturday January First, 2012; 2012-01-01; 1/1/2012)” to include different date formats. Time is often discussed in qualitative terms instead of quantitative terms (or the reverse). For example, a record may indicate that an event occurred at 8 pm. To help locate this record, the inference system may add the word “night” to the record if it was 8 pm during winter or the inference system may add the word “dusk” to the record if it was 8 pm during summer. Sometimes criminals have time based patterns of behavior such that terms like “payday” or “weekend” may be added to records that describe events that occur on pay days or weekends, respectively. In one embodiment, the system consults a calendar and indicates if a date is a holiday. For example, the speculative text of Table 4 noted that the incident date “is a weekend day, and a holiday (New Year's Day).”

Suspect descriptions also often contain a mix of qualitative and quantitative terms. Additional terms may be added to improve search results. For example, a man under a certain height threshold may be labeled as “short” and over a certain height threshold may be described as “tall”. A fuzzy-logic based inference system may be used to add descriptive terms. For example, a five foot tall and 200 pound person may be labeled as “heavy” whereas a six foot and four inch person that is 200 pounds may be labeled as having a “thin build”.

Geographic location information can be very important in solving crimes. The standard police movie scene of a map with pushpins marking the location of crimes is still literally used in modern police offices at times. But the modern computer graphical rendition is heavily used by criminal analysts to help solve crimes. Certain types of crimes are often associated with various landmarks such that adding synthesized text that contains location information with nearby landmarks can be very helpful. Modern police reports often include latitude and longitude information read from GPS receivers. Thus, given a record with a specified address or latitude and longitude coordinates, the inference system may add sentences with geographical landmark phrases such as “near skyline high school”, “near freeway”, “near park”, “in a Hispanic neighborhood”, “near stadium”, “near mall”, etc. as appropriate. In one embodiment, the granularity of the system is down to individual rooms. Thus, the synthesized text of Table 4 includes the sentence “The latitude/longitude 37.8013, −122.1639 is inside the cafeteria at Skyline High School.”

Various information codes may be entered into documents that can be decoded and put into natural language such that relevant records may be more likely to be identified. For example, police call codes may be changed into natural language name for the type of incident. Vehicle Identification Numbers (VINs) contain a wealth of information that can be expanded out into natural language. For example, a record that involves a car with VIN code ‘1N19G9J100001’ may be expanded to include “a 1979 4-door Chevrolet (Chevy) Caprice”.

Many speculative types of inferences may be added to a speculative text field to help find records that would not normally be located. One technique is to add speculative text that points out common misperceptions made by witnesses. For example, when conditions are dark then a blue car looks very similar to a green car. Thus, these two car colors are frequently misreported during dark conditions due to human physiology. Thus, for reports that contain car descriptions with blue cars may be labeled with green in a speculative field (and reports that contain car descriptions with green cars may be labeled with blue in a speculative field). Other speculations may include alternate names of items. People often use variants and different spellings of names such that the speculative field may contain different spellings and name variants of names contained in a primary field.

The weather is known to affect the types of crimes that occur at various times. Thus, by combining dates and places in a data record along with accurate weather reports, data records may be modified to include synthesized text with weather information. For example, the database tables for the incident report in Table 3 concerns a crime committed on January First, 2012 in Oakland, Calif. and an accurate weather report system specified that it was raining on January First, 2012 in Oakland, Calif. such that the inference system added the synthesized sentence “The weather was rainy on the incident date in Oakland Calif.” to the speculative text field for the data record.

Request Processing and Response Generation System

After constructing the unified conventional structured database 252 and the modified natural language database 253, these two different databases are made available to law enforcement officers. Both databases generally contain the same information but the formats of the two databases are very different and thus enable different types of searching to be performed.

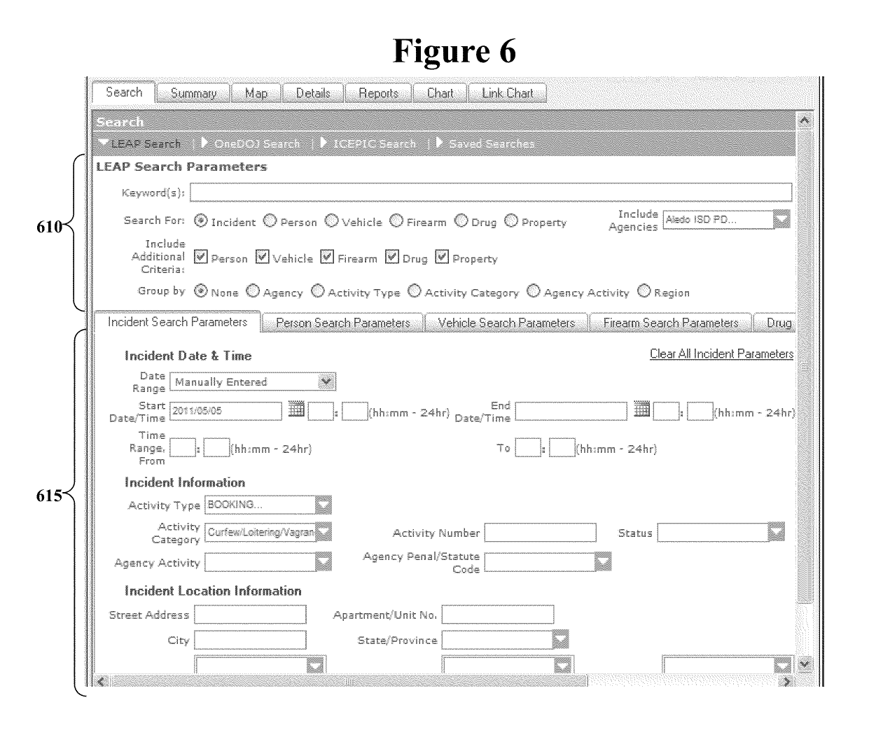

The conventional structured database 252 can be made available to law enforcement officers using a convention user interface 291. FIG. 6 illustrates a screen shot of a typical database interface may comprise a structured form with a number of different fields where officers may enter search parameters to create a database query. In the particular example of FIG. 6, the top area 610 allows the user to specify the type of reports that are being searched for and the bottom area 615 allows the user to enter detailed search terms for the different types of reports in the system. Such structured search forms work well for crime analysts and detectives that have time to sit at a desk, click on option boxes, fill in search fields, and do the necessary work to obtain detailed information. The conventional structured database 252 operates the same as existing records management systems that officers may have many years of experience working with. However, many law enforcement information system users wanted a quicker and easier search system that could provide relevant search results upon entering a few keywords into a simple search box interface.

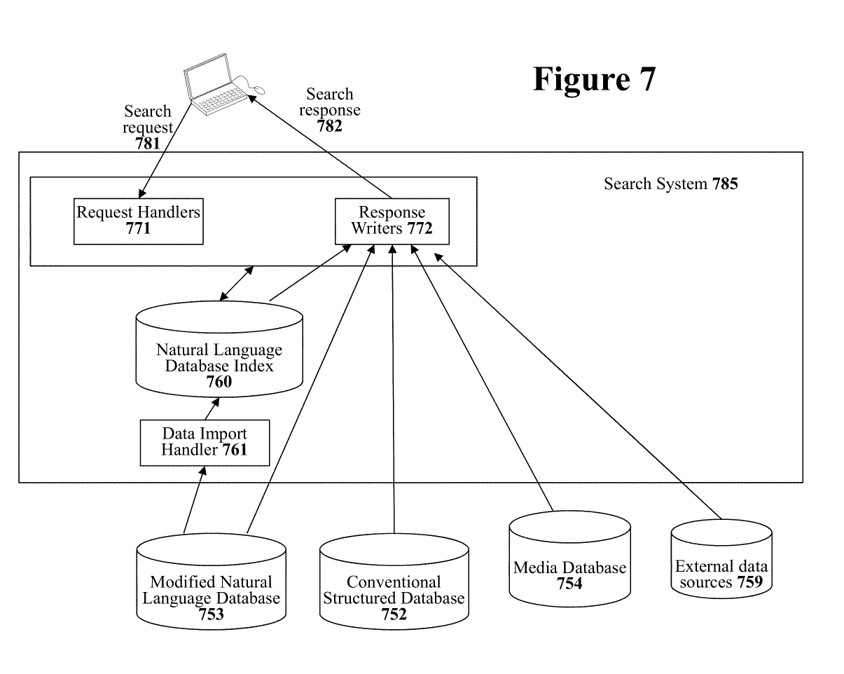

To satisfy the need for a quicker and easier search system, a powerful search system 285 that operates using the modified natural language database 253 was developed. In one embodiment, the search system 285 is implemented with the Apache Lucene project software. FIG. 7 illustrates a more detailed block diagram of the search system 785.

Referring to FIG. 7, a data important handler 761 reads all of the data record entries created in the modified natural language database 753 to create a natural language database index 760. As is well-known in the art, the index 760 keeps track of which documents contain which words so that keyword searches can be used to quickly identify documents in the modified natural language database 753 that contain some or all of the requested keywords.

In normal operation the search system 785 directs a received search request 781 to a request handler 771. The request handler 771 examines the keyword search request and may modify the search request to obtain better results. For example, the keywords in the search request may be processed by stemming and other standard search engine techniques in order to match more results as is well-known in the art.

In addition, various specific techniques directly related to law enforcement searching may be applied to the search achieve better search results. For example, commonly used acronyms like “WM” used in place of “White Male” may be expanded out to include the full text. The name of a gang may be expanded out to include other known names for the same gang or a closely related gang. Crimes are categorized in a number of ways, so that rapes and shootings can be found when you search for ‘violent crimes’. After processing the keyword search terms, the search system 785 examines the natural language database index 760 to identify a set of candidate documents for the search results.

After having identified a set of candidate documents, the search system 785 calculates a relevance score for each the various documents. The documents with significant matches in the important text section of a document will receive higher relevance scores than those documents with matches in the less important text section or the speculative text section of a document.

Once all of the candidate documents have been assigned a relevance score, a response writer 772 is invoked to create a response web page for the search results. In one embodiment, the created search results web page lists a set of documents links along some data previewed. The preview data may be fetched from a stored preview cache in the natural language database index 760.

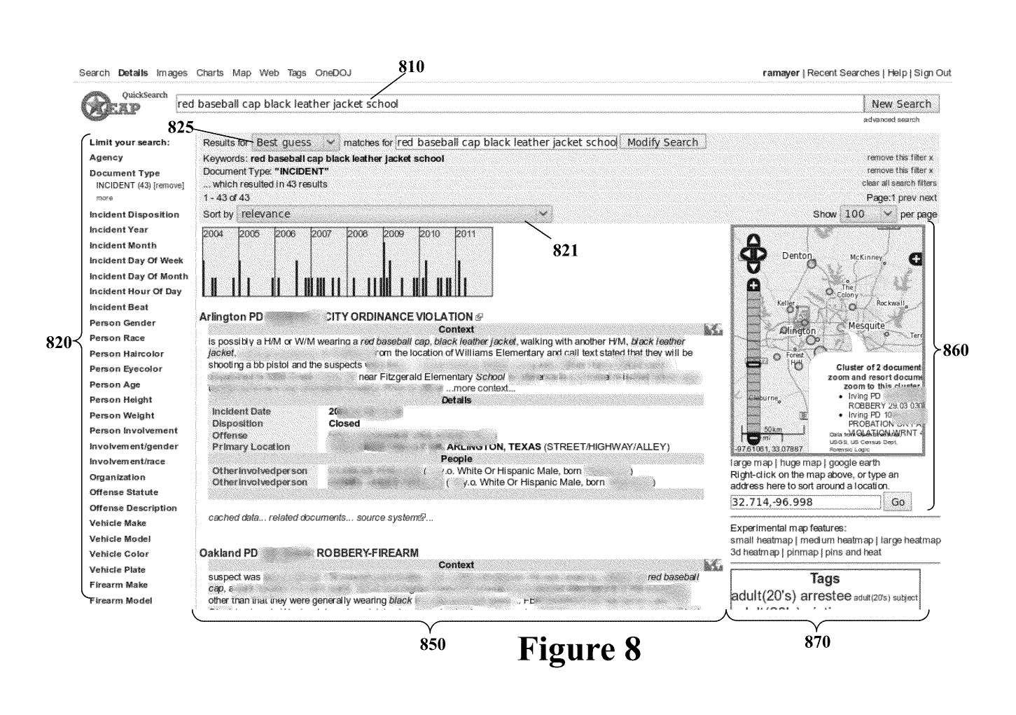

FIG. 8 illustrates a screenshot of a search results output for one embodiment. At the top of FIG. 8 is a keyword search box 810 where the search keywords are entered. The document links and preview data from the first two search results are displayed in a central area 850. A set of filters 820 are listed on the left side that allows the user to filter the search results. A pull-down menu item 821 allows the results to be sorted in a different order.

The user interface may include a pull-down menu 825 that allows the user to specify which data fields should be searched. In one embodiment of the user interface, the user chooses between “Exact Match”, “Best Guess”, and “Wild Guess” with pull-down menu 825. With “Exact Match”, the system may only search the original source data fields. The “Best Guess” setting allows the system to search additional fields such as the high confidence inferences. The “Wild Guess” setting allows the search system to search all of the fields including fields that include speculative inferences such as “a dark green car can look dark blue at night” or uncommon nicknames.

In addition to the standard search results 850, the output screen also displays geographic pushpin type of map 860 wherein relevant records are displayed as pushpins on a geographic map. Additional information on the data records displayed in the map 860 may be retrieved by clicking on the search pins. In the bottom right-corner, a portion of a word cloud 870 is displayed that is constructed using a set of commonly occurring words in the search results.

The document links displayed in the search results 850 may link to the record in the modified natural language database 753 but often link to different source for the information. For example, if a data record was originally created from tables in a database, instead of pointing to the synthesized record in the natural language database 753 the document link may instead comprise a database query to obtain the original record in structured database 752. Document links may also point to external data sources 759 such records in original police databases or publicly accessible web sites. When records contain various media items (images, audio, video, documents, etc.), that media may be easily accessed from the media database 754 that was created during the data acquisition phase.

The preceding technical disclosure is intended to be illustrative, and not restrictive. For example, the above-described embodiments (or one or more aspects thereof) may be used in combination with each other. Other embodiments will be apparent to those of skill in the art upon reviewing the above description. The scope of the claims should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim is still deemed to fall within the scope of that claim. Moreover, in the following claims, the terms “first,” “second,” and “third,” etc. are used merely as labels, and are not intended to impose numerical requirements on their objects.

The Abstract is provided to comply with 37 C.F.R. §1.72(b), which requires that it allow the reader to quickly ascertain the nature of the technical disclosure. The abstract is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

We claim:

1. A method of processing and storing information for easy retrieval, said method comprising:
reading a source data record;
creating a natural language data record;
synthesizing a first natural language narrative of said source data record in said natural language record;
generating a set of rational inferences from said source data record;
synthesizing a second natural language narrative in said natural language record from said set of rational inferences;
storing said natural language data record in a modified natural language database; and
indexing and searching said modified natural language database with a text search engine.

2. The method of processing and storing information for easy retrieval as set forth in claim 1 further comprising:
creating a simple text conversion from said source data record; and
placing said simple text conversion in said natural language data record.

3. The method of processing and storing information for easy retrieval as set forth in claim 1 further comprising:
assigning importance levels to different sections of text in said natural language data record.

4. The method of processing and storing information for easy retrieval as set forth in claim 3 wherein speculative inferences from said set of rational inferences are placed in a speculative text field.

5. The method of processing and storing information for easy retrieval as set forth in claim 1 wherein said source data record comprises an XML record.

6. The method of processing and storing information for easy retrieval as set forth in claim 1 wherein said source data record comprises a database table.

7. The method of processing and storing information for easy retrieval as set forth in claim 1 wherein one of said set of rational inferences comprises a landmark near a location listed in said source data record.

8. The method of processing and storing information for easy retrieval as set forth in claim 1 wherein one of said set of rational inferences comprises a weather condition that occurred at a time and a location listed in said source data record.

9. The method of processing and storing information for easy retrieval as set forth in claim 1 wherein one of said set of rational inferences comprises a common misperception made by humans.

10. The method of processing and storing information for easy retrieval as set forth in claim 1 wherein one of said set of rational inferences comprises additional description information obtained by extracting a code value from said source data record and using said code value as a key into a database to obtain said additional description information.

11. A database system for processing and storing information for easy retrieval, said database system comprising:
a structured database for storing structured data records;
a natural language database for storing natural language data records;
a data collection system, said data collection system collecting source data records from more than one source data repository;
a structured record creator, said structured record creator converting said source data records into structured data records stored in said structured database;
a natural language database record creator, said natural language database record creator creating natural language data records by synthesizing natural language text from said source data records; and
a search engine system, said search engine system for indexing and searching said natural language database.

12. The database system for processing and storing information for easy retrieval as set forth in claim 11 wherein a subset of said source data records comprise XML data records.

13. The database system for processing and storing information for easy retrieval as set forth in claim 11 wherein a subset of said source data records comprise a set of tables read from a database.

14. The database system for processing and storing information for easy retrieval as set forth in claim 11 wherein said natural language database record creator extracts data values from said source data records and creates natural language narratives by inserting said data values into scripts.

15. The database system for processing and storing information for easy retrieval as set forth in claim 11 wherein said natural language database record creator assigns importance levels to different sections of said natural language text.

16. The database system for processing and storing information for easy retrieval as set forth in claim 11 wherein said search engine system reduces word spaces between words in a compound adjective-noun clause.

17. The database system for processing and storing information for easy retrieval as set forth in claim 11 wherein said search engine system increases word spaces between separate adjective-noun clauses.

18. The database system for processing and storing information for easy retrieval as set forth in claim 11 wherein said natural language database record generates rational inferences from said source data records.

19. The database system for processing and storing information for easy retrieval as set forth in claim 18 wherein one of said rational inferences comprises a weather condition that occurred at a time and a location listed in one of said source data records.

20. The database system for processing and storing information for easy retrieval as set forth in claim 18 wherein one of said rational inferences comprises a common misperception made by humans.
